(19) United States
(12) Patent Application Publication
(10) Pub. No.: US 2007/0050241 A1
(43) Pub. Date: Mar. 1, 2007

(54) System For Enhancing Web-based Marketing Efficiency of Fragmented Business

(76) Inventors: John O. Jones, Arcadia, OK (US); Johnathan Kelley, Sandy, UT (US)

Correspondence Address: A PATENT LAWYER CORP, PC;R WILLIAM GRAHAM, 22 S ST CLAIR ST, DAYTON, OH, 45402, US

(21) Appl. No.: 11/162,109

(22) Filed: Aug. 29, 2005

(51) Int. Cl. G06Q 30/00

(52) U.S. Cl. 705/14

(57) ABSTRACT

A system and method for enhancing web-based marketing efficiency of fragmented business includes an exchange server computer having exchange server software operably associated with the publisher's web site having fragmentation software which is equipped to prompt a viewer to enter a path determining zone of fragmentation information where upon entry of such path determining zone of fragmentation information the exchange server software can be initiated to direct the viewer to an advertiser's goods or service.

### BACKGROUND OF INVENTION

1. Field of the Invention

The present invention relates to a system for marketing business on Internet World Wide Web sites and more particularly to a system for enhancing web-based marketing efficiency of fragmented business.

2. Background of the Invention

Many web sites on the Internet World Wide Web regularly display advertisements. The particular advertisement that is displayed when a viewer accesses a web site can either be stored locally on the web site or it can be stored on a central server. (As used herein, the term viewer refers to an individual who views or looks at a web page using a program such as a web browser).

The Hyper Text Transfer Protocol (HTTP) and the Hyper Text Mark Up Language (HTML) provide mechanisms whereby a web page can easily reference material located on a remote server. The HTTP/HTML mechanisms for referencing and obtaining material from a remote server are useful in providing advertising material for display to the viewers.

Systems exist for providing advertising to web sites from a central server wherein such web pages have HTML references to this central server. With such an arrangement, when a viewer accesses a web page which has an appropriate HTML reference, the viewer sees an advertisement that is provided by the central server. In addition, standard HTTP services are provided to track when a particular viewer accesses a web site and thus it is possible to compile a data base which provides a profile of the sites a particular viewer has accessed. From this, viewers can be tracked using cookie technology or the like for targeting particular advertisements to particular categories of viewers.

In addition, prior art systems exist for enhancing the manner in which advertising can be accomplished over the Internet. For example, paid marketing search engines developed wherein a viewer can submit a search term relating to a particular business service or desired good whereby the search engine generates a listing of links to web pages (which can be advertisers and non-advertisers). By clicking on the link, a specific web page advertiser is displayed. Ranking of the links is typically a function of the highest bidding advertiser. The web site advertiser is charged for the pass through by what is known in the art as the “pay per click” charge. Paying advertisers aim to drive viewers to their web site through this existing paradigm. Enhancements to this marketing paradigm have also been developed.

Several U.S. Pat. Nos. 6,269,361, 6,826,572 and 6,876,997, 6,285,987 and U.S. Patent Application 2001/0051940 disclose various enhancements to search engines in which advertisers can influence their position in ranking. U.S. Pat. No. 6,269,361, for example, is directed at improving the prior systems through an ongoing online competitive bidding process. U.S. Pat. No. 6,826,572 provides means for grouping advertiser search listings into advertiser defined categories and for managing multiple advertiser defined categories for the advertiser search listings, the advertiser defined categories being independent of search listing search terms and allows advertisers to manage the categories of search listings in the database. U.S. Pat. No. 6,876,997 provides a related searches database to provide the results of related searches with those generated as part of a search result. U.S. Pat. No. 6,285,987 is directed to an Internet advertising system using a bidding agent for selecting the highest bid or for selecting the highest bid among electronic bids received within a specific time period. U.S. Patent Application 2001/0051940 provides for a search listing associated with an advertiser and includes one search term and bid amount modifiably bid by the advertiser, arranging the search result list in random order.

Also, advertisers who use such prior art systems typically specify in advance the targeting criteria they want to use for their advertisements. The server then provides advertisements to viewers based upon criteria appealing to the particular viewer.

While these innovations have aided many advertisers, often the viewer is unable to be serviced by the advertiser due to the viewer failing to meet certain qualifications or that the advertiser is providing a collateral service and not directly providing a desired service or good. Thus, a paid advertising charge is not necessarily fruitful to the advertiser and/or the viewer who meets a dead end at the site.

The present invention aids in solving this problem and overcomes part of the deficiencies of the art as will be apparent from the following description and drawings.

### SUMMARY OF THE INVENTION

It is an object to improve advertising over the Internet.

It is an object to improve retrieval of services/goods provider information pursuant to a request by a consumer.

It is another object to provide a vehicle to market fragmented business prospects from a related or collateral business wherein such prospects are generated by a publisher and provided to a paying advertiser(s) who has contracted with an exchange server, wherein the exchange server is the business device that deploys the invention. The publisher can be a direct provider of a predetermined goods or services or a content provider for such goods or services. Similarly, the advertiser can be a provider of predetermined goods or services.

The present invention provides an improved method and system for enhancing web-based marketing efficiency of fragmented business, wherein fragmented business is defined to include a particular set of zones of fragmentation associated specifically with a type of business. Accordingly, one aspect of the present invention is directed to a system for enhancing web-based marketing efficiency of fragmented business. The system can include an exchange server computer having exchange server software thereon which is operably associated with a publisher's web site that is equipped to prompt a viewer to enter path determining fragmentation information corresponding to one zone of fragmentation, where upon entry of such path determining fragmentation information, either the publisher's web site displays its good/service or the exchange server software transmits an advertiser's link or linked advertisement to the viewer. In a preferred embodiment, the exchange server software is equipped to charge a fee to the advertiser payable indirectly to the publisher through the exchange server for clicks arising from view-ops generated through the publisher's web site.

The invention is employed in an environment wherein the publisher's web site drives viewers to its publisher web site through conventional means. Once at the publisher's site, the viewer is required by fragmentation software on the publisher's web site to select from a plurality of predetermined fragmented zones owning to a particular business. A publisher which generated the initial visitor and handles certain fragmented zones as determined by the fragmentation software whereas another advertiser contracts with the exchange to handle one or more of the unhandled fragmented zones as determined by the exchange server and fragmentation e-commerce software. The advertiser pays the exchange for the traffic sent to the advertiser and in addition, a service charge can be made to either or both of the publisher or advertiser for the use of the exchange server.

The exchange server software can store data, such as advertisement information about advertisers, information about the characteristics of a particular web site and other information relevant to which advertisements should be displayed for particular viewers. The exchange server software enables advertisers to bid for a particular group of fragmented zones in order to determine which particular advertisement will be displayed to a viewer.

The fact that a viewer has accessed a web page which has an HTML reference linked to the advertiser is herein referred to as a view opportunity or view-op. The characteristics of each view-op include the characteristics of the particular web site and web page being accessed and the characteristics of the viewer and can include demographic information about the viewer and information as to what other sites this viewer has accessed in various periods of time are obtainable.

With the present invention each advertiser can contract with the publisher or ideally the exchange server software handles one or more “proposed bids” which specify how much the advertiser is willing to pay for consumer visits in response to a view-op with a particular group of fragmented zones (i.e., fragmented zones not handled by the publisher ).

The present invention provides a very flexible system whereby advertisers can minimize cost and maximize effectiveness while the owners of web sites can produce revenue for displaying advertisements on their site.

### BRIEF DESCRIPTION OF THE DRAWINGS

FIG. 1 is a block diagram of a preferred embodiment of the invention.

FIG. 2 depicts a screen shot of a web page of a step performed in operation of the invention.

FIG. 3 depicts another screen shot of another web page of a step performed in operation of the invention.

FIG. 4 depicts yet another screen shot of a web page of a step performed in operation of the invention.

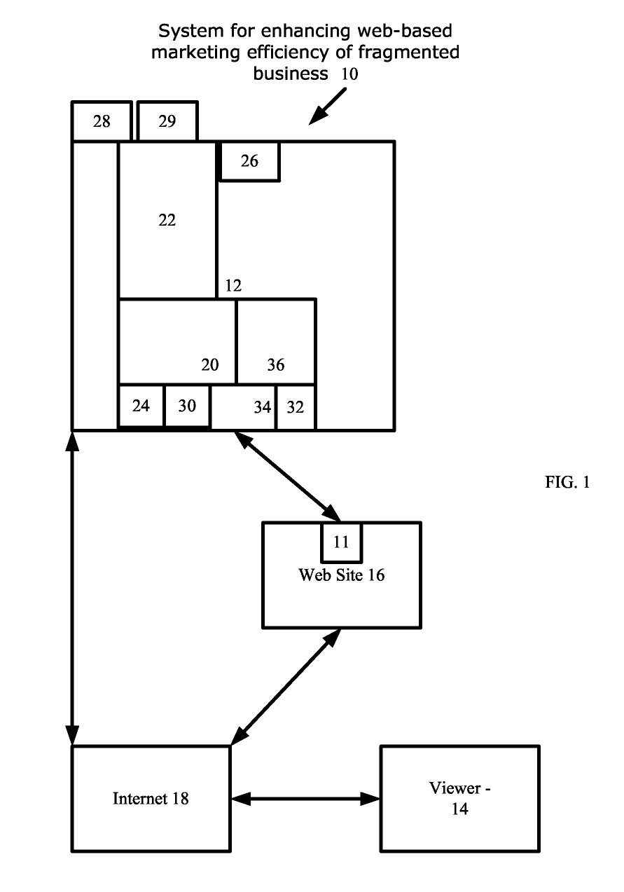

### DETAILED DESCRIPTION OF EMBODIMENTS OF THE INVENTION

Referring now to the drawings, a preferred embodiment of the system for enhancing web-based marketing efficiency of fragmented business is generally designated by the numeral 10. In a contemplated embodiment, the system 10 can for provide advertisements 11 to be displayed through exchange server 12 to viewers 14 who access a web sites 16. The web site 16 can be stored on another computer remotely located from the exchange server 12 and is accessible via the Internet 18. The exchange server computer 12 can be equipped with a suitable memory 20, a processor and associated board circuitry 22, an operating system 24 operably associated with the memory 20, power 26, keyboard 28, display 29 and connectivity to the Internet 18, as is known in the art.

Further, the exchange computer 12 is equipped for storing data 32 within a database 34 within the memory 20. The data 32 can preferably include data related to zones of fragmentation of a particular type of business. Exchange server software 30 can be operably associated with the web site 16 can be stored in the memory 20.

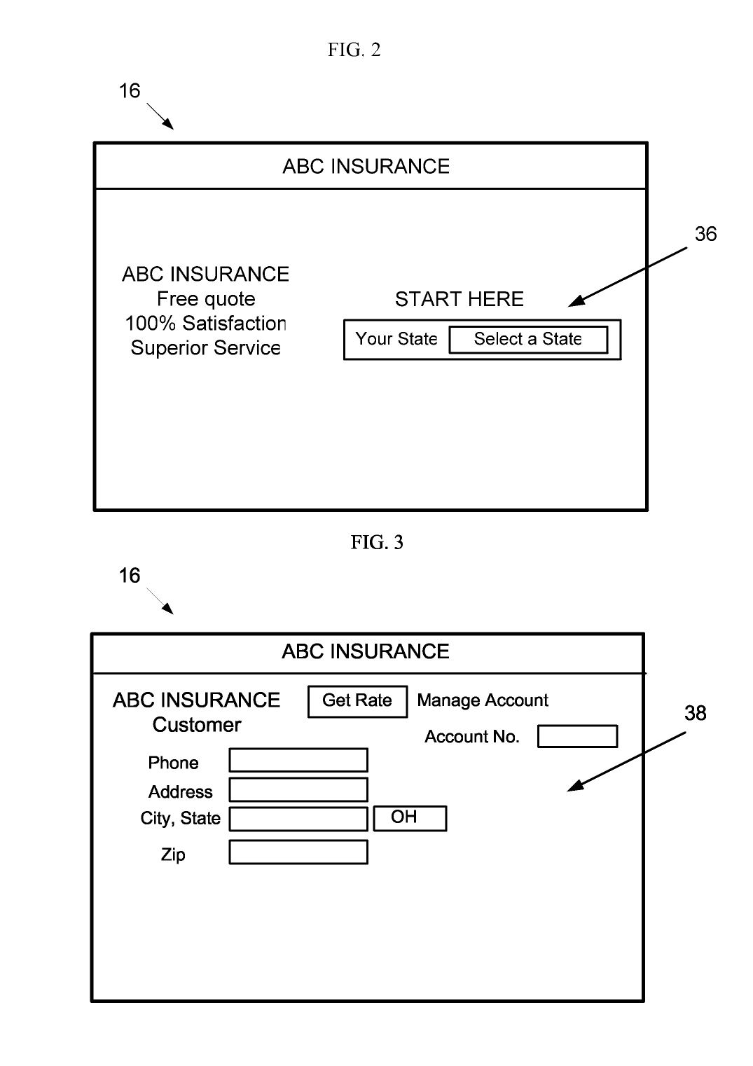

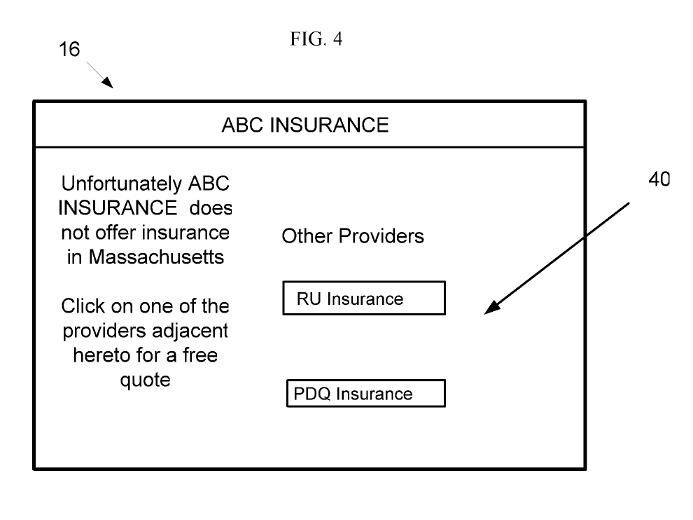

FIG. 2 depicts publisher's web site 16 (e.g., ABC Insurance) which can be operably associated with the exchange server computer 12 is operably associated with exchange server software 30 such that it is equipped to prompt a viewer 14 to enter path determining fragmentation information 36 corresponding to one of the zones of fragmentation. In this example, path determining fragmentation information 36 is shown as prompting to select a state wherein zones of fragmentation include states. Upon entry of such path determining fragmentation information 36, either the publisher's web site 16 displays the publisher's good/service advertisement 38 as seen in FIG. 3 (i.e., those handled by the publisher ) or the exchange server software 30 transmits an advertiser link or linked advertisement of an advertiser good/service 40 (e.g., RU Insurance, PDQ Insurance) as seen in FIG. 4 (i.e., those not handled by the publisher, but by the advertiser).

In a preferred embodiment, the software 30 is equipped to generate charge a fee to the advertiser payable to the publisher for viewer clicks generated through the path from the publisher's web site. The publisher can be a direct provider of a predetermined goods or services or a content provider for such goods or services. Similarly, the advertiser can be a predetermined provider of goods or services or a content provider for such goods or services.

Thus, the present invention provides for the system 10 for enhancing web-based marketing efficiency of fragmented business. In one embodiment, the invention is employed in a conventional web environment wherein the publisher's web site 16 is operably associated with a marketing search engine, such as with Yahoo or Google, which drives viewers to the publisher's web site 16. Once at the publisher's web site 16, the viewer 14 is required by the publisher's web site 16 to select from a plurality of predetermined fragmented zones , wherein each of the fragmented zones are associated exclusively with one of at least two different entities, such as publisher and advertiser. For example, the publisher can be equipped to handle and desires to retain potential customers in twenty five predetermined states while other states are handled by one or more of the advertisers, e.g., RU or PDQ in which the publisher receives a referral fee.

In this embodiment, the publisher which generated the initial visitor handles certain fragmented zones whereas the other advertiser(s) who contracted with the exchange server 12 handles one or more of the unhandled fragmented zones as can be determined by the exchange server software 30. The advertiser indirectly pays the publisher through the exchanger server 12 for what would otherwise be lost fragmented zones at the publisher's web site 16.

The exchange server 12 can store advertisements and web pages, i.e., data 32 relating to fragmentation zones which are to be stored in information data base 34. The data base 34 can include data information 32 about viewers, information about the characteristics of particular web site(s), and other information relevant to which advertisements should be displayed for particular viewer 14. The exchange server software 30 can be operably associated with the data base 34 in a manner to obtain information data about the viewer 14 and to obtain information data about characteristics of particular web site and retrievably write such information data to the database 34. The software 30 can also be equipped to enable the advertisers to bid for a particular group of fragmented zones as determined by the exchange server software 30 to determine which particular advertisement will be displayed to viewer 14.

The fact that a viewer 14 has accessed web page 16 which has an HTML reference to the advertiser of the present invention is herein referred to as a view opportunity or view-op. The characteristics of each view-op include the characteristics of the particular web site and web page being accessed and the characteristics of the viewer 14 include demographic information about the viewer 14 and information as to what other sites this viewer has accessed in various periods of time.

With the present invention each advertiser can contract with the publisher or ideally have the exchange server software 30 handle one or more “proposed bids” which specify how much the advertiser is willing to pay for a particular group of fragmentation zones and in turn advertisement in response to a “click through”. Each proposed bid can specify a price or amount that the advertiser is willing to pay for visits from viewer 14 who has a need for a particular good/service not handled by the publisher on the publisher's web site 16. Each proposed bid can be dependent upon or require satisfaction of various criteria which can be predetermined and governed by the software 30 which must be met in order for a bid of a particular amount to be submitted for the particular group of fragmentation zones. For example, an advertiser might bid for all the Massachusetts'viewer fragmented zones. The amount bid for a click through can be dependent on as many criteria as is defined by the exchange server software 30. The present invention thus provides a very efficient way to market fragmented zones.

The above described embodiment is set forth by way of example and is not for the purpose of limiting the present invention. It will be readily apparent to those skilled in the art that obvious modifications, derivations and variations can be made to the embodiment without departing from the scope of the invention. Accordingly, the claims appended hereto should be read in their full scope including any such modifications, derivations and variations.

What is claimed is:

1. A system for enhancing web-based marketing efficiency of fragmented business, which includes:
an exchange server computer operably associated with a publisher's web site having fragmentation software thereon which is operably associated with said publisher's web site and which is equipped to prompt a viewer to enter a path determining zone of fragmentation information at said web site, where upon entry of such path determining zone of fragmentation information, said publisher's web site displays one of publisher's goods and service advertisement or prompts said exchange server software to transmit one of an advertiser's goods and service advertisement.

2. The system of claim 1, wherein said exchange server software is equipped to generate a visit fee to an advertiser payable indirectly to the publisher through the exchange server software for a click through generated through said path from said publisher's web site.

3. The system of claim 1, wherein said publisher is one of a direct provider of a predetermined goods and services and a content provider for goods and services.

4. The system of claim 1, wherein said advertiser is a direct provider of a predetermined goods and services.

5. The system of claim 1, which further includes a database having data relating to a plurality of predetermined zones of fragmentation accessible through said exchange server software, wherein each data is owning exclusively to one of said publisher and said advertiser.

6. The system of claim 1, wherein said exchange server software is operably associated with a data base to obtain information data about the viewer and retrievably write said information data to said database.

7. The system of claim 1, wherein said exchange server software is operably associated with a data base to obtain information data about characteristics of a particular web site and retrievably write said information data to said database.

8. The system of claim 1, wherein said exchange server software enables advertisers to bid for a particular restricted group of viewers as determined by said fragmentation software using said zones of fragmentation.

9. A method of marketing efficiency of fragmented business, which includes:
(a) providing an exchange server computer operably associated with a publisher's web site having fragmentation software thereon which is operably associated with said publisher's web site and which is equipped to prompt a viewer to enter a path determining zone of fragmentation information at said web site, and
(b) entering said path determining zone of fragmentation information causing one said publisher's web site to exclusively display to said viewer one of a publisher's goods and service advertisement or said exchange server software to transmit an advertiser's goods and service advertisement.

10. The method of claim 9, which includes employing said exchange server software to charge fee to an advertiser for fragmentation information generated through said publisher's web site.

11. The method of claim 9, wherein said publisher is one of a direct provider of a predetermined goods and services and a content provider for goods and services.

12. The method of claim 9, wherein said advertiser is a direct provider of a predetermined goods and services.

13. The method of claim 9, which further includes employing a database having a plurality of predetermined zones of fragmentation accessible through said exchange server software, wherein each data is owning exclusively to one of said publisher and said advertiser.

14. The method of claim 9, which further includes employing said exchange server software to be operably associated with a data base to obtain information data about the viewer and store said information data in a retrievable manner.

15. The method of claim 9, which further includes employing said exchange server software to be operably associated with a data base to obtain characteristic data of particular web site and store said characteristic data in a retrievable manner.

16. The method of claim 9, wherein said exchange server software enables advertisers to bid for a particular restricted group of viewers as determined by said exchange server software using said zones of fragmentation.
